(19) United States
(12) Patent Application Publication
(10) Pub. No.: US 2023/0181994 A1
(43) Pub. Date: Jun. 15, 2023

(54) SKIPPING ROPE

(71) Applicant: Jianjun Liu, Quanzhou (CN)

(72) Inventors: Jianjun Liu, Quanzhou (CN); Binglei Liu, Quanzhou (CN); Lengyi Liu, Quanzhou (CN)

(21) Appl. No.: 17/547,292

(22) Filed: Dec. 10, 2021

(51) Int. Cl. A63B 71/06; G06F 3/14; A63B 5/20; A63B 24/00; A63B 21/00

(52) U.S. Cl. CPC A63B 71/0622; G06F 3/1446; A63B 5/20; A63B 24/0062; A63B 21/4035; A63B 21/00181; A63B 2071/065; A63B 2071/0658; A63B 2220/17; A63B 2225/50; A63B 2225/64; A63B 2225/66

(57) ABSTRACT

Provided is a skipping rope. The skipping rope allows the rope skipping times being counted and displayed in the form of light, facilitating users and others to learn about the rope skipping times. The skipping rope comprises two handles, a rope arranged between the two handles, a counting module located on one of the two handles for counting the rope skipping times, a display device arranged within the rope and electrically connected with the counting module for displaying the rope skipping times in the form of light after the counting module counts the rope skipping times.

### TECHNICAL FIELD

The present application relates to the technical field of skipping rope, in particularly to a skipping rope.

### BACKGROUND

Rope skipping is a sports game in which one person or a group of people do various jumping actions in a looping rope. This is an ancient folk entertainment activity in Chinese Han people throughout history, and was called “Tou Suo” in Tang Dynasty, “Tiao Suo” in Song Dynasty, “Tiao Bai Suo”, “Tiao Bai Suo”, “Tiao Ma Suo” in Ming Dynasty, and “Sheng Fei” in Qing Dynasty. Since the Southern Song Dynasty, rope skipping game has been performed every festive season and every family is intended to take part in.

Chinese Patent No. 201820845166. 7 discloses a tangle-free skipping rope, including a skipping rope handle and a skipping rope. One end of the skipping rope handle is provided with a skipping rope rewinding rotating cover. One end of the skipping rope rewinding rotating cover is provided with a rotating cover fixing thread. One side of the skipping rope rewinding rotating cover is provided with a rotating cover fixing sleeve. The rotating cover fixing sleeve is slidably connected with the skipping rope handle through a sliding groove. The skipping rope rewinding rotating cover and the rotating cover fixing sleeve are attached by screwing connection through the rotating cover fixing thread. One side of the rotating cover fixing thread is provided with a rotating winding column, and the rotating winding column is fixedly connected with the rotating cover fixing thread by a screw. One side of the rotating winding column is provided with a fixed buckle. The rotating winding column and the skipping rope are fixedly connected by the fixed buckle. One end of the skipping rope handle is provided with a skipping rope winding hole. The skipping rope winding hole is installed on the skipping rope handle to rotate the winding column. One side of the skipping rope is provided with an inner elastic rubber strip for the skipping rope, the surface of the skipping rope is provided with an outer plastic anti-wear sleeve for the skipping rope. The inner elastic rubber strip for the skipping rope and the outer plastic anti-wear sleeve for the skipping rope are fixed. One end of the outer plastic anti-wear sleeve of the skipping rope is provided with a skipping rope anti-wear rotating ring. Preferably, a bearing is arranged on the inner side of the anti-wear rotating ring of the skipping rope, and the inner ring of the bearing is fixedly connected with the elastic rubber strip in the skipping rope by viscose. Preferably, the anti-wear rotating rings of the skipping rope are connected in rotation through a bearing. Preferably, a limit plate is provided at one end of the skipping rope winding and rotating cover, and the limit plate and the skipping rope handle are slidably connected by a sliding groove. Preferably, the surface of the skipping rope handle is provided with a rubber non-slip sleeve. Compared with the prior art, the beneficial effect of the present invention is that by designing the anti-wear rotating ring in the middle section of the skipping rope, the middle section of the skipping rope rubs against the ground when the skipping rope is used. The sliding friction can be converted to rolling friction to reduce the abrasion or breakage of the skipping rope; by designing the rotating reel in the skipping rope handle and the skipping rope rewinding rotating cover, after the skipping rope is used, the rotating cover can be rewinded by rotating the skipping rope. Winding the skipping rope on the rotating reel can prevent the skipping rope from being entangled when storing the skipping rope, and can control the length of the skipping rope when using the skipping rope.

Although the above-mentioned patents can solve the corresponding technical problems, they still have certain defects:

The counted rope skipping times cannot be displayed in the form of light, which is not conducive to the user or others to know the rope skipping times, is less interesting, and is not conducive to the user's use.

### SUMMARY

The purpose of the present disclosure is to address the defects and deficiencies of the prior art, and provide a device capable of displaying the counted rope skipping times in the form of light, which is helpful for users or others to know the rope skipping times, is interesting, and is beneficial to users.

In order to achieve the above purpose, the following solutions are adopted in the present disclosure.

A skipping rope, comprises two handles, a rope arranged between the two handles, a counting module located within one of the two handles for counting rope skipping times, a display device arranged within the rope and is electrically connected to the counting module for displaying the rope skipping times in a light form after the counting module counts the rope skipping times.

The display device comprises a main control module arranged within one of the two handles, a plurality of LED modules arranged within the rope; the main control module comprises a main processor, wherein an output terminal of the main processor is connected to a 2-wire bus; each LED module is consist of slave control module and a plurality of LED wafers, wherein the slave control module comprises a slave processor, the slave processor comprising two bus connection pins, a plurality of address pins, and a plurality of output pins; the two bus connection pins are connected to the 2-wire bus, respectively; the plurality of address pins are connected to different voltages for different communication address configuration; and the plurality of output pins are connected to the plurality of LED wafers.

In some embodiments, the plurality of output pins of the slave processor of the slave control module are connected to COM pins of the slave module after in connection with the plurality of LED wafers, respectively; the plurality of address pins of the slave processor are connected to different voltages through a voltage output port of the slave processor, so as to realize the configuration of different communication address.

In some embodiments, the main control module further comprises a button module, a power supply module, a wireless communication module, and a music module; the counting module comprises an acceleration sensor; the main processor is electrically connected to the button module, the power supply module, the wireless communication module, the music module and the acceleration sensor, respectively.

In some embodiments, the wireless communication module is a Bluetooth module, a Zigbee module, or a WiFi module.

In some embodiments, the handle comprises a handheld portion, a lower cover detachably arranged at a lower end of the handheld portion, and a holding cavity formed between the handheld portion and the lower cover for accommodating cleaning products.

In some embodiments, an upper end of the handheld portion is detachably provided an upper cover for the rope to pass through; each end of the rope is provided with a stopper, preventing the rope from departing from the upper cover.

In some embodiments, the handle is provided with a counterweight that increases the weight of the handle and facilitating users to use the skipping rope.

In some embodiments, a protective part is detachably provided on the handle.

In some embodiments, the protective part comprises a warming layer for protecting hands in winter, and a cooling layer opposite to the warming layer for cooling then hands in summer.

By using the above technical solution, the present disclosure has the following beneficial effects: users may hold the two handles with both hands to perform rope skipping movement, the counting module is capable of counting the rope skipping times, and the display device is capable of displaying the skipping rope in the form of light after the counting module counts the rope skipping times. The rope skipping times can be displayed in the form of light, which is helpful for users or other people to know the number of skipping ropes. It is interesting and beneficial to users.

Furthermore, by designing a main control module and multiple LED modules, the multiple LED modules are connected in parallel to the 2-wire bus, and the main control module provides power access and control signal input for the multiple LED modules through the 2-wire bus. Through the main control module sending multiple addresses and control commands to realize the blinking control of the LED module. No additional control circuit is needed for blinking control, and it can be realized by only using the power cord already have.

### BRIEF DESCRIPTION OF THE DRAWINGS

In order to clearly describe the technical solutions in the embodiments of the present disclosure or the prior art, the following will briefly introduce the drawings that need to be used in the description of the embodiments or the prior art. Obviously, the drawings in the following description are just some embodiments of the present disclosure. For those of ordinary skill in the art, other drawings may be obtained based on these drawings without creative labor.

FIG. 1 is a schematic diagram of skipping rope of the present disclosure.

FIG. 2 is a cross-sectional view of FIG. 1.

FIG. 3 is a schematic diagram of the protective part of the present disclosure.

FIG. 4 is a schematic circuit diagram of the main control module according to embodiments of the present disclosure.

FIG. 5 is a schematic circuit diagram of the slave control module according to embodiments of the present disclosure.

### DETAILED DESCRIPTION OF THE EMBODIMENTS

Now the present disclosure is further described with reference to the drawings and specific embodiments.

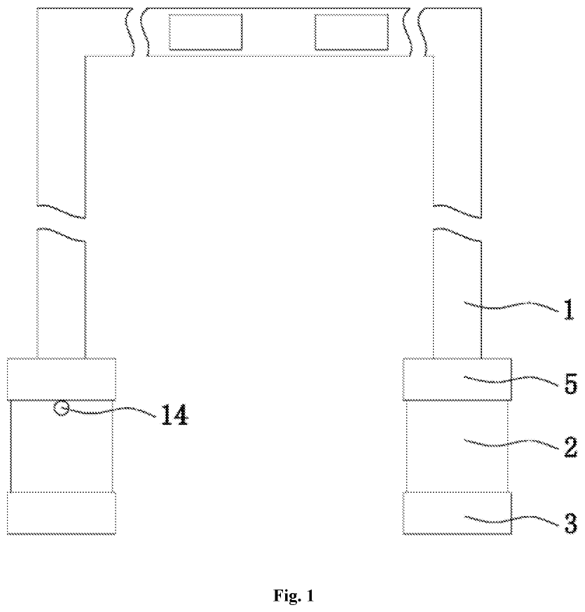

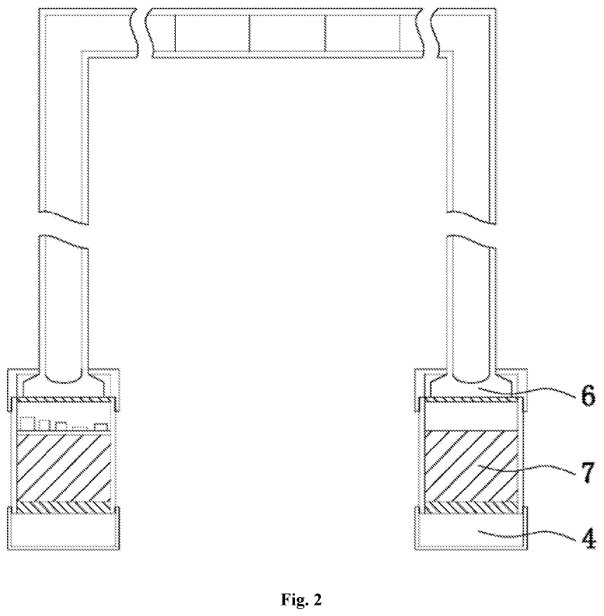

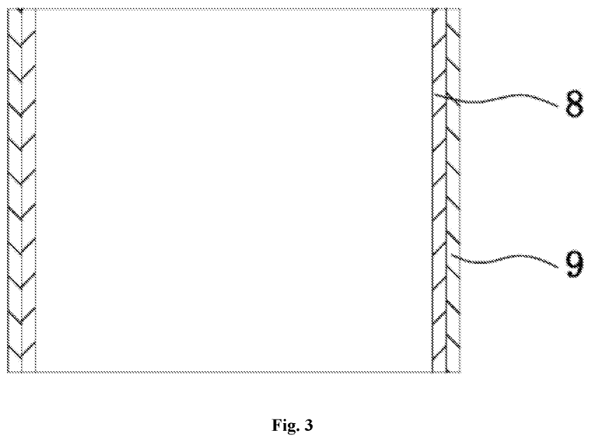

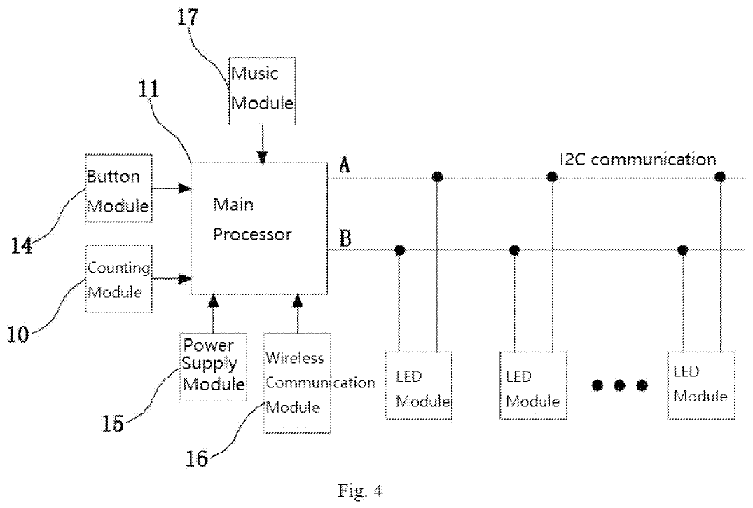

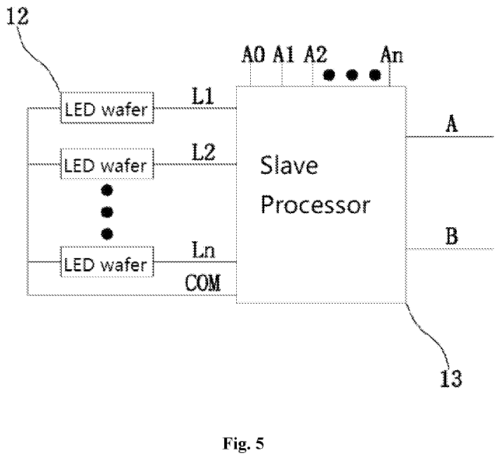

Referring to FIG. 1 to FIG. 5, the embodiments therein is as follows.

A skipping rope comprises two handles. A rope 1 is arranged between the two handles. The handle comprises a handheld portion 2, a lower cover 3 detachably arranged on a lower end of the handheld portion 2 by thread connection, and a holding cavity 4 formed between the handheld portion 2 and the lower cover 3 for accommodating cleaning products. The cleaning products may include dry tissue, wet tissue and the like. An upper end of the handheld portion 2 is detachably provided with an upper cover 6, by thread connection, allowing the rope 1 to pass through. Each end of the rope 1 is provided with a stopper 6, preventing the rope 1 from departing from the upper cover 5. A counterweight 7 is arranged within the handheld portion 2 for increasing the handheld weight and improving user experience. The counterweight 7 may be an iron block, a lead block and the like. A protective part is detachably arranged on the handheld portion 2. The protective part comprises a warming layer 8 for providing hands warm feeling in winter and protecting hands, and a cooling layer 9 opposite to the warming layer for providing hands cool feeling in summer and protecting hands. The warming layer 8 and the cooling layer 9 both are made of fabric. The counting module 10 is located within the left handheld portion 2 for counting the rope skipping times. The counting module 10 comprises an acceleration sensor. The acceleration sensor is a triaxial accelerometer. The display device is provided within the rope and is electrically connected to the counting module 10 for displaying the rope skipping times in the form of light after the counting module 10 counts the rope skipping times. The display device comprises a main control module arranged within one of the two handles, and a plurality of LED modules arranged within the rope 1. The main control module comprises main processor 11. An output terminal of the main processor 11 is connected to a 2-wire bus. Each LED module is consisted of a slave control module and a plurality of LED wafers. The slave control module comprises a slave processor 13. The slave processor 13 comprises two bus connection pins, a plurality of address pins, and a plurality of output pins. The two bus connection pins are connected to the 2-wire bus, respectively. The plurality of address pins are connected to different voltages for realizing different communication address configurations. The plurality of output pins are connected to the plurality of LED wafers. The plurality of output pins of the slave processor 13 of the slave control module are connected to a COM pin of the slave control module after in connection with the plurality of LED wafers 12. The plurality of address pins of the slave processor 13 are connected to different voltages through a voltage output port of the slave processor 13, so as to realize different communication address configurations. The main control module further comprises a button module 14, a power supply module 15, a wireless communication module 16, a music module 17. The main processor 11 is electrically connected to the button module 14, the power supply module 15, the wireless communication module 16, and the music module 17, respectively. The power supply module 15, the wireless communication module 16, the music module 17, the main processor 11, the counting module 10 all are arranged within the left handheld portion 2. The wireless communication module 16 is Bluetooth module, Zigbee module or WiFi module. The button module 14 is a button. The power supply 15 is a rechargeable battery. The music module 16 is a Bluetooth speaker. The left handheld portion 2 further comprises a charge pore (not shown) for recharging the rechargeable battery.

The the present disclosure works as follows. The skipping rope provided by the present disclosure has configure addresses for each LED (built-in control IC) in production. For example, the plurality of address pins of the slave control module of LED1 is connected to different voltages through the voltage output port of the processor 13 for realizing different communication address configurations. After booting, all LEDs are powered through the 2-wire bus. The cooperation of button module 14 or wireless host and the wireless communication module 16 allows a command to be sent to the main processor 11. After the main processor 11 receives the command, the main processor 11 sends different display commands to LEDs having different addresses, respectively. The slave processor receives the matched command, and displays the corresponding status. For example, the main processor 11 sends addresses A0, A1, A2, . . . , An of L1 and control command, and L1 executes the corresponding status display while the other LEDs remain unresponsive. Similarly, the main processor 11 may send multiple of addresses and control commands to different LEDs for the LEDs displaying different status.

Users may grasp the two handheld portions 2 separately for rope skipping. The counting module 10 is configured for counting rope skipping times. The display device is configured for displaying the rope skipping times in the form of light after the counting module 10 counts the rope skipping times. The plurality of LED modules is capable of displaying the rope skipping times in the form of light, facilitating users or others to learn about the rope skipping times. The power supply module 15 is configured to supply power to the skipping rope. The music module 17 is configured to paly digital audio. When the warming layer 8 needs to be used, the cooling layer 9 is turned over so that the cooling layer 9 is covered on and contacts the surface of the handheld portion 2. When the cooling layer 9 is needed to be used, the warming layer 8 is turned over so that the warming layer 8 is covered on and contacts the surface of the handheld portion 2.

What is claimed in the present disclosure is the structure of the whole product. The type of the counting module 10, the main processor 11, the LED wafer 12, the slave processor 13, the button module 14, the power supply module 15, the wireless communication module 16, and the music module 17 is also well-known in the art. Those having the same or similar functions on the market can be deemed as an alternative. The present disclosure will not go detail here.

The basic principles, main features and advantages of the present disclosure are shown and described above. Those skilled in the art should understand that the present disclosure is not limited by the above-mentioned embodiments. The above-mentioned embodiments and descriptions only illustrate part of the present disclosure. Without departing from the spirit and scope of the present disclosure, the present disclosure will have various equivalent changes and improvements. These changes and improvements fall within the scope of the claims. Anything not described in detail in the present disclosure is well-known to those skilled in the art.

What is claimed is:

1. A skipping rope, comprising
two handles,
a rope arranged between the two handles,
a counting module located within one of the two handles for counting rope skipping times,
a display device arranged within the rope and is electrically connected to the counting module for displaying the rope skipping times in a light form after the counting module counts the rope skipping times;
the display device comprises a main control module arranged within one of the two handles, a plurality of LED modules arranged within the rope; the main control module comprises a main processor, wherein an output terminal of the main processor is connected to a 2-wire bus; each LED module is consist of slave control module and a plurality of LED wafers, wherein the slave control module comprises a slave processor, the slave processor comprising two bus connection pins, a plurality of address pins, and a plurality of output pins; the two bus connection pins are connected to the 2-wire bus, respectively; the plurality of address pins are connected to different voltages for different communication address configuration; and the plurality of output pins are connected to the plurality of LED wafers.

2. The skipping rope according to claim 1, wherein the plurality of output pins of the slave processor of the slave control module are connected to COM pins of the slave module after in connection with the plurality of LED wafers, respectively; the plurality of address pins of the slave processor are connected to different voltages through a voltage output port of the slave processor, so as to realize the configuration of different communication address.

3. The skipping rope according to claim 1, wherein the main control module further comprises a button module, a power supply module, a wireless communication module, and a music module; the counting module comprises an acceleration sensor; the main processor is electrically connected to the button module, the power supply module, the wireless communication module, the music module and the acceleration sensor, respectively.

4. The skipping rope according to claim 3, wherein the wireless communication module is a Bluetooth module, a Zigbee module, or a WiFi module.

5. The skipping rope according to claim 1, wherein the handle comprises a handheld portion, a lower cover detachably arranged at a lower end of the handheld portion, and a holding cavity formed between the handheld portion and the lower cover for accommodating cleaning products.

6. The skipping rope according to claim 5, wherein an upper end of the handheld portion is detachably provided an upper cover for the rope to pass through; each end of the rope is provided with a stopper, preventing the rope from departing from the upper cover.

7. The skipping rope according to claim 1, wherein the handle is provided with a counterweight that increases the weight of the handle and facilitating users to use the skipping rope.

8. The skipping rope according to claim 1, wherein a protective part is detachably provided on the handle.

9. The skipping rope according to claim 8, wherein the protective part comprises a warming layer for protecting hands in winter, and a cooling layer opposite to the warming layer for cooling then hands in summer.
